(19) United States
(12) Patent Application Publication
(10) Pub. No.: US 2015/0027410 A1
(43) Pub. Date: Jan. 29, 2015

(54) TIGHTLY EXTRUSION-COATED COMPONENT AND METHOD FOR PRODUCING SUCH A COMPONENT

(71) Applicant: Ralf Kromer, Vaihingen An Der Enz (DE)

(72) Inventor: Ralf Kromer, Vaihingen An Der Enz (DE)

(73) Assignee: Robert Bosch GmbH, Stuttgart (DE)

(21) Appl. No.: 14/386,682

(22) PCT Filed: Feb. 12, 2013
(86) PCT No.: PCT/EP2013/052733

§ 371 Date: Sep. 19, 2014

(30) Foreign Application Priority Data
Mar. 19, 2012 (DE) 10 2012 204 310.1

(51) Int. Cl. F16L 3/10; F16L 21/00; F02M 61/16

(52) U.S. Cl. CPC F16L 3/1058; F02M 61/168; F16L 21/005
USPC 123/445; 264/279; 428/189; 428/174; 428/166

(57) ABSTRACT

A component is described as including a base part, a sealing element, and an extrusion coat, which extends at least partially around the base part and at least partially around the sealing element, the extrusion coat keeping the sealing element in an elastically deformed state.

### FIELD OF THE INVENTION

The present invention relates to a component which is extrusion-coated by a further material. In addition, the present invention relates to a method for producing an extrusion-coated component, and to a fuel injection device for an internal combustion engine which includes an extrusion-coated component according to the present invention.

### BACKGROUND INFORMATION

Especially metallic base parts that are extrusion-coated by a plastic material are known from the related art. However, insufficient anchoring of the extrusion coat on the base part frequently occurs because of the different expansion coefficients of base part and extrusion coat. Micro gaps therefore appear, into which liquid or gaseous media can penetrate, aided by the capillary effect. This lack in tightness can therefore lead to undesired corrosion manifestations. Furthermore, endeavors for improving the tightness between base part and extrusion coat are known from the related art. A labyrinth seal, for example, may be used for such a purpose, in that one or more recesses is/are introduced into the base part, which are filled by the extrusion-coated plastic during the extrusion process. However, this technique has shown to have an insufficient sealing effect as well.

Nonetheless, especially when components are involved that are subject to frequent and large temperature fluctuations, it is desirable to have the extrusion coat rest tightly against the base part.

### SUMMARY

The component according to the invention includes a base part and a sealing element. The sealing element is fixed in place on a surface of the base part. The component also includes an extrusion coat, which at least partially extends around the base part and at least partially around the sealing element. The tightness between the base part and the extrusion coat is ensured in that the extrusion coat keeps the sealing element in an elastically deformed state. As a result, the sealing element is deformed and clamped between base part and extrusion coat, which makes it possible to achieve high tightness between the extrusion coat and the base part. Furthermore, the component according to the present invention ensures the tightness also in the presence of temperature fluctuations or relative movements between base part and sealing element.

In one preferred specific embodiment of the present invention, the sealing element forms a sealed space in conjunction with the base part. A gas, which is compressed, in particular, is situated within this space. The pressure of the compressed gas additionally acts on the sealing element, which in turn has a positive effect on the tightness. The robustness of the seal with respect to temperature fluctuations or other changeable environmental influences is enhanced further as a result. In addition, the space is developed in such a way that the sealing element can elastically deform appropriately in response to temperature fluctuations or a change in environmental influences, to continue to ensure the tightness. In particular, the space is developed in such a way that the extrusion coat does not penetrate this space.

Especially preferably, the base part has a recess, which is covered by the sealing element. This creates the sealed space between sealing element and base part. The production expense for this specific embodiment is quite low, since a recess is easy to produce. The sealing element need merely be large enough to cover the recess.

As an alternative, it is preferably provided that the sealing element has a cup shape or a bowl shape provided with an opening. This opening is covered by the base part. In contrast to the previous embodiment, in which the space was situated within the base part and was covered by the sealing element, the space now lies within the sealing element and is covered by the base part. The requirements on the shape of the base part are therefore able to be lowered. It must only have a surface that is large enough to cover the opening of the cup shape or the bowl shape.

In a third, especially preferred alternative, the base part has two surfaces that are situated at an angle relative to each other. The sealing element extends between the angled surfaces, thereby creating the space between base part and sealing element. This variant is useful especially when already existing locations having angled surfaces are present on the base part. In this case, the sealing element is able to be secured in such a location in a simple manner that requires little work.

In one advantageous specific embodiment of the present invention, the base part and/or the sealing element is/are completely surrounded by the extrusion coat. The complete extrusion coating of the sealing element enables a maximum elastic deformation, so that very high tightness is achieved between extrusion coat and base part. For example, the complete extrusion coating of the base part provides increased corrosion protection of the base part.

As an alternative preferred specific embodiment of the present invention, the sealing element is placed against two surfaces of the base part situated at an angle with respect to each other. The contacting is without a gap, so that no space appears between the sealing element and the base part. In this case, the sealing effect is due solely as a result of the restoring force of the elastic deformation of the sealing element, which acts both on the extrusion coat and the base part. The tightness between base part and extrusion coat obtained in this manner is essentially as great as the tightness in the previously mentioned specific embodiments.

In the undeformed state, the sealing element is preferably annular, preferably with a rectangular cross-section. The base part is preferably made of a metallic material, while the extrusion coat is preferably made of plastic.

The present invention furthermore relates to a method for producing an extrusion-coated component, which includes the following steps: First, a base part and a sealing element are provided, which sealing element is subsequently secured on the base part. Finally, another material is used to at least partially extrusion-coat the base part and the sealing element. In addition, the sealing element is elastically deformed by this extrusion-coating process, and retained in this deformed state via the extrusion coat. This produces an extrusion-coated component which has high tightness between the base part and extrusion coat. The tightness is ensured by the sealing element, which is elastically deformed and thus clamped, so that it applies a pressure force both on the extrusion coat and the base part.

The method is preferably executed by securing the sealing element on the base part in such a way that a closed space is created between base part and sealing element. Enclosed in this space is a gas, which is compressed by the elastic deformation of the sealing element during the extrusion coating. The compressed gas therefore exerts an additional force on the sealing element, which further increases the tightness between base part and extrusion coat. The space is developed in such a way that no liquid material is able to penetrate the sealed space during the extrusion-coating. Moreover, the space is developed in such a way that the sealing element is able to be further elastically deformed in response to temperature fluctuations or changing environmental influences. In this way the tightness between base part and extrusion coat is ensured even in the presence of temperature fluctuations or changing environmental influences.

As an alternative, the method of the present invention is preferably executed by placing the sealing element against two surfaces of the base part that are angled with respect to each other. The contacting placement has no gaps and thus ensures that no space is created between the sealing element and the base part. An injection molding die provided with a cavity is used during the extrusion coating, into which the sealing element is pressed during the extrusion coating process. The extrusion coat ultimately retains the sealing element in this elastic deformation. This method dispenses with the production of a space filled with compressed gas, so that the tightness between base part and extrusion coat is created simply by the restoring force of the sealing element resulting from the elastic deformation. The execution of this method is very simple and requires little effort.

In addition, the present invention relates to a fuel injection device for an internal combustion engine. This fuel injection device includes a component according to the invention, as described in the previous paragraphs.

### BRIEF DESCRIPTION OF THE DRAWINGS

FIG. 1 a sectional view of a component according to a first specific embodiment of the present invention, prior to the extrusion-coating.

FIG. 2 a sectional view of the component according to a second specific embodiment of the present invention, following the extrusion-coating.

FIG. 3 a sectional view of a component according to a second specific embodiment of the present invention, prior to the extrusion-coating.

FIG. 4 a sectional view of the component according to a second specific embodiment of the present invention, following the extrusion-coating.

FIG. 5 a sectional view of the component according to a third specific embodiment of the present invention, prior to the extrusion-coating.

FIG. 6 a sectional view of the component according to the third specific embodiment of the present invention, following the extrusion-coating.

FIG. 7 a sectional view of a component according to a fourth specific embodiment of the present invention, during the extrusion coating process, and a tool that has been used for this purpose.

FIG. 8 a sectional view of the component according to the fourth specific embodiment of the present invention, following the extrusion-coating.

FIG. 9 a schematic view of a fuel injector, which includes a component of the present invention according to one of the preferred specific embodiments.

### DETAILED DESCRIPTION

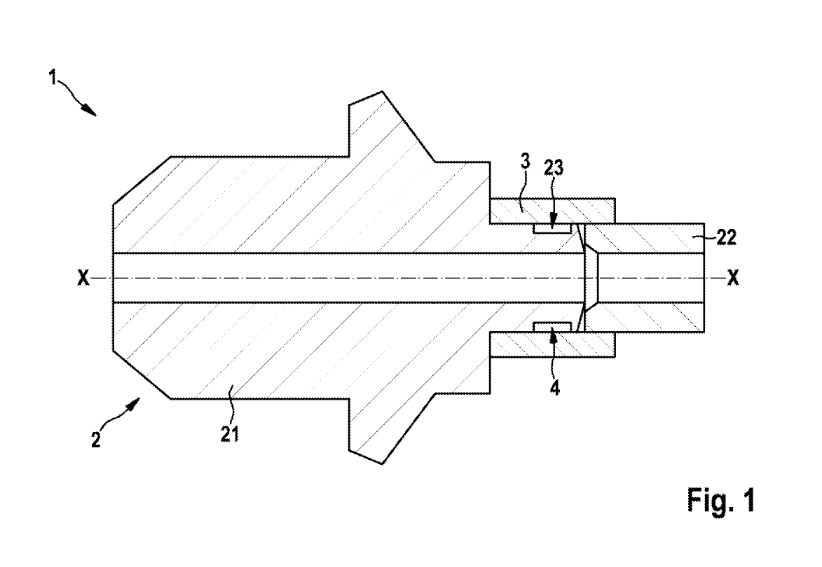

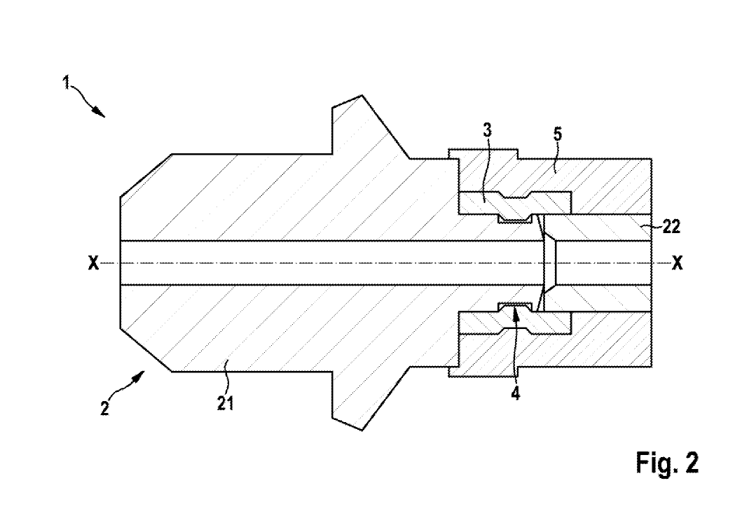

FIGS. 1 and 2 represent a sectional view of component 1 of the present invention, according to a first specific embodiment. FIG. 1 shows component 1 before extrusion coat 5 is applied, and FIG. 2 shows component 1 after an application of extrusion coat 5. FIG. 1 reveals that a sealed annular space 4 is formed by a recess 23 within a two-piece base element 2 having a first part 21 and a second part 22. A sealing element 3 is placed over this recess 23, which encapsulates space 4 from the environment. Sealing element 3 thereby ensures that no molten mass is able to make its way into space 4 during the extrusion coating process. FIG. 2 shows component 1 after extrusion coat 5 has been applied. It can be seen that sealing element 3 has been elastically deformed by extrusion coat 5. Since sealing element 3 penetrates space 4 in the process, the gas contained therein is compressed. This further compresses sealing element 3, so that it produces a robust seal between base part 2 and extrusion coat 5. However, sealing element 3 does not completely penetrate space 4, so that sealing element 3 retains the ability to deform into the remaining space, for example in response to temperature fluctuations.

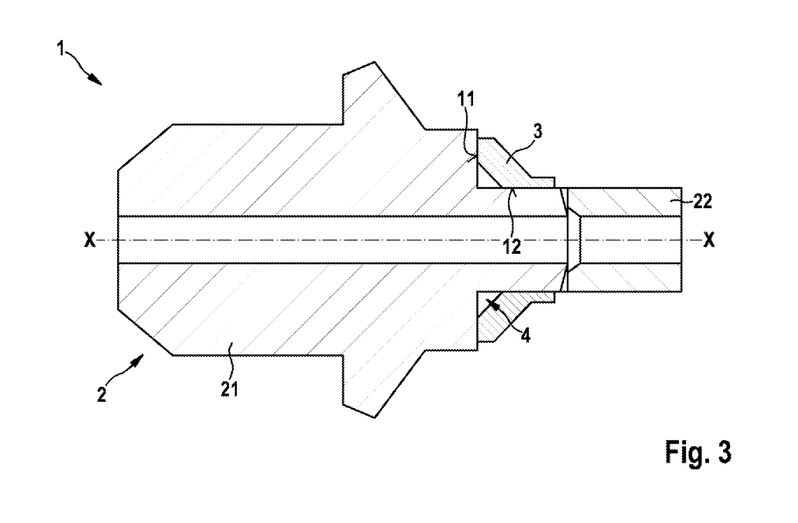

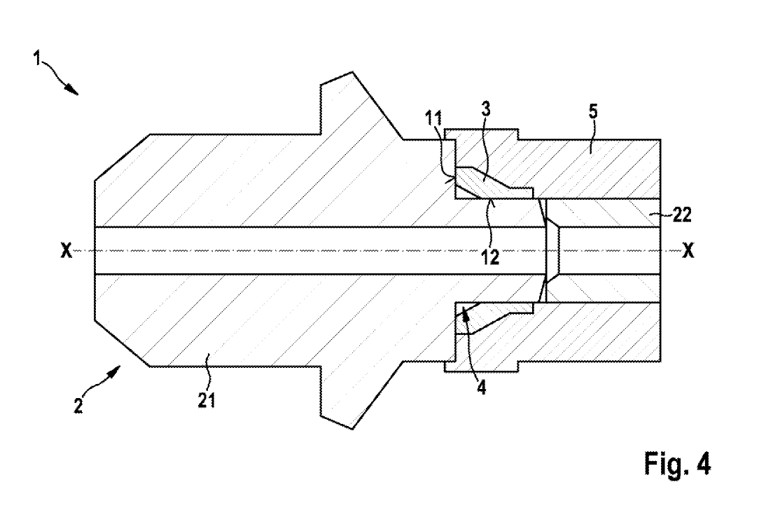

FIGS. 3 and 4 represent a sectional view of component 1 of the present invention, according to a second specific embodiment. FIG. 3 shows component 1 before extrusion coat 4 is applied; and FIG. 4 shows component 1 after an extrusion coat 5 has been applied. FIG. 3 indicates that component 1 has two surfaces that are angled with respect to each other. A first surface 11 is orthogonal to a second surface 12. A sealing element 3 extends from first surface 11 to second surface 12. In the process, a sealed annular space 4 is created between sealing element 3 and base part 2. Here, too, sealing element 3 seals space 4, so that it is encapsulated from the environment. In particular, no molten mass can enter this space during the extrusion coating process, and furthermore, no gas is able to escape from space 4. FIG. 4 shows component 1 after an extrusion coat 5 has been applied. In an analogous manner to the first specific embodiment, component 3 has been elastically deformed by extrusion coat 5, so that the gas situated inside space 4 was compressed. Here, too, sealing element is compressed within this space 4 by the elastic deformation and by the pressure of the compressed gas, thereby ensuring the tightness between base part 2 and extrusion coat 5. In this specific development, base part 2 need not undergo further processing; in particular, it need not have any recesses since existing angled surfaces 11 and 12 are utilized.

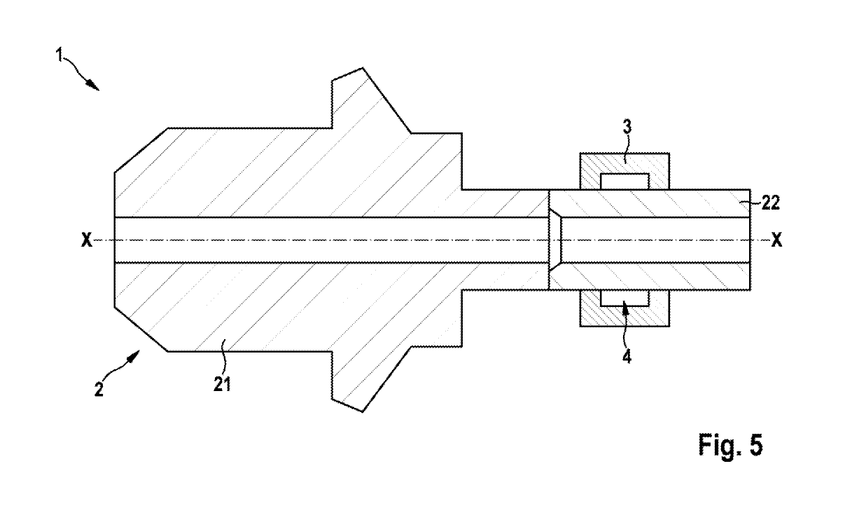

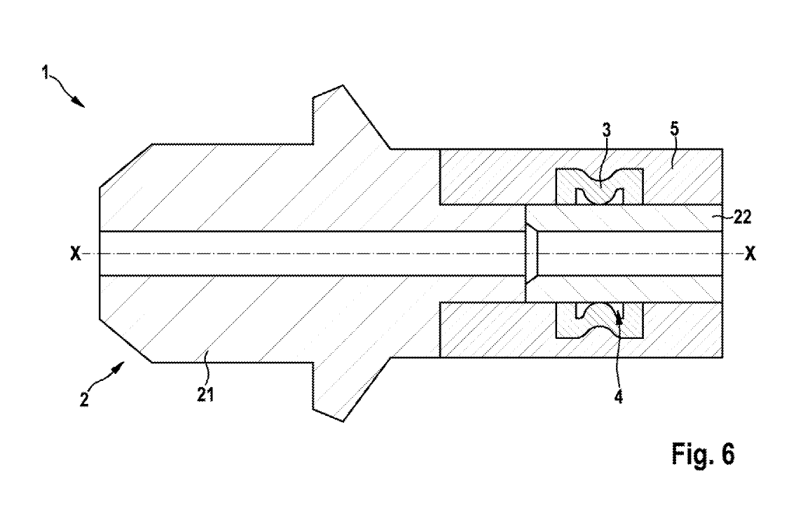

FIGS. 5 and 6 show a sectional view of component 1 of the present invention, according to a third specific embodiment. FIG. 5 shows component 1 before extrusion coat 6 is applied; and FIG. 6 shows component 1 following the application of an extrusion coat 5. FIG. 5 illustrates that in this exemplary embodiment, annular sealing element 3 has a cup shape in section, whose opening is covered by base part 2. The opening is provided at an inner circumference of sealing element 3. As a result, a space 4 is created within sealing element 3, which further reduces the constructional requirements on base part 2. Here, too, sealing element 3 ensures that no molten mass is able to enter space 4 during the extrusion coating and that no gas can escape from space 4. FIG. 6 shows component 1 after extrusion coat 5 has been applied. Sealing element 3 was elastically deformed in this case as well, so that the gas situated in space 4 was compressed. The same functionality results as in the first two exemplary embodiments, but it is clear that extrusion coat 5 is able to be applied in a more compact manner. In addition, the single condition made on the base part in this development is that it have a surface that is large enough to cover the opening of sealing element 3.

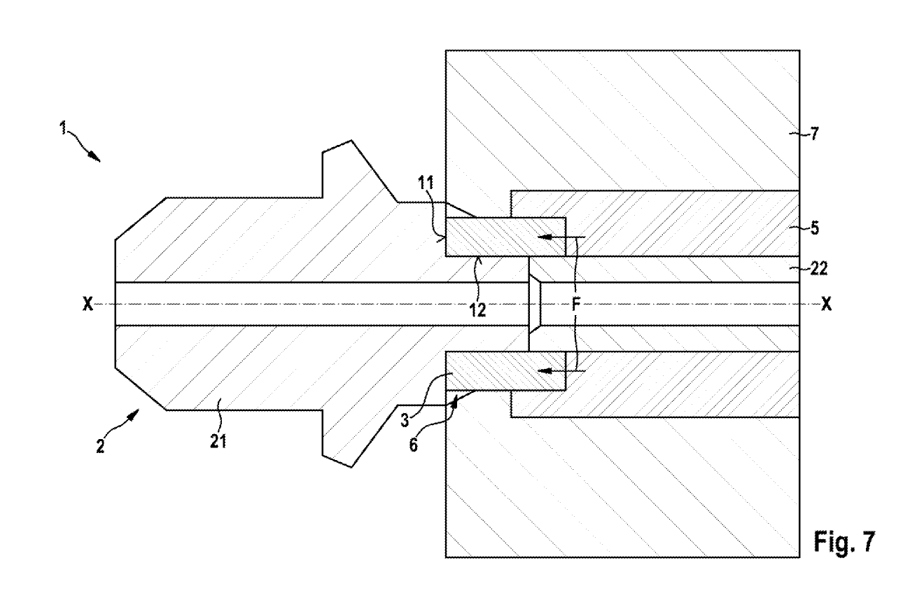

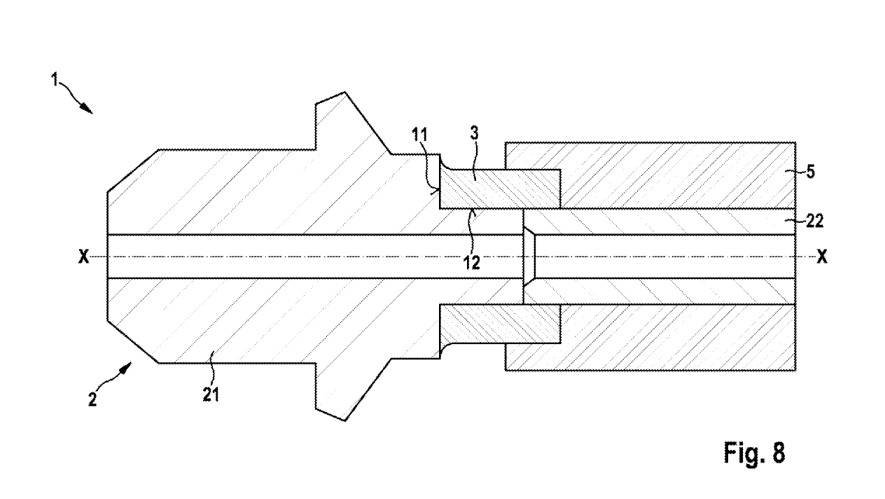

FIGS. 7 and 8 show a sectional view of component 1 of the present invention, according to a fourth specific embodiment. FIG. 7 shows component 1 during the extrusion coating process; and FIG. 8 shows component 1 following the extrusion coating process. It is clear from FIG. 7 that an injection molding die 7 is used during the extrusion coating of base part 2 with an extrusion coat 5. Injection molding die 7 is resting on sealing element 3, so that it is extrusion-coated only partially. Once again, sealing element 3 is resting against first surface 11 and second surface 12 of base part 2, but without forming a space between the sealing element and base part. To ensure that sealing element 3 is still able to elastically deform during the extrusion coating, injection molding die 7 has a cavity 6, into which sealing element 3 is pressed while extrusion coat 5 is applied. The result can be seen in FIG. 8. It is obvious that sealing element 3 is clamped between extrusion coat 5 and base part 2 in axial direction X-X as a result of force F applied during the extrusion coating. Thus, a restoring force that results from the elastic deformation of sealing element 3 generates a pressure force both on base part 2 and extrusion coat 5. This realizes safe sealing between extrusion coat 5 and base part 2.

Since sealing element 3 is only partially extrusion coated in axial direction X-X in this specific development, it continues to be elastically deformable even after extrusion coat 5 has been applied. As a result, this specific embodiment, too, provides high tightness when exposed to changing temperature influences. However, since no space is provided like in the other specific embodiments, there is no need to ensure that molten mass cannot penetrate this space during the extrusion coating. This simplifies the work involved in the extrusion coating process.

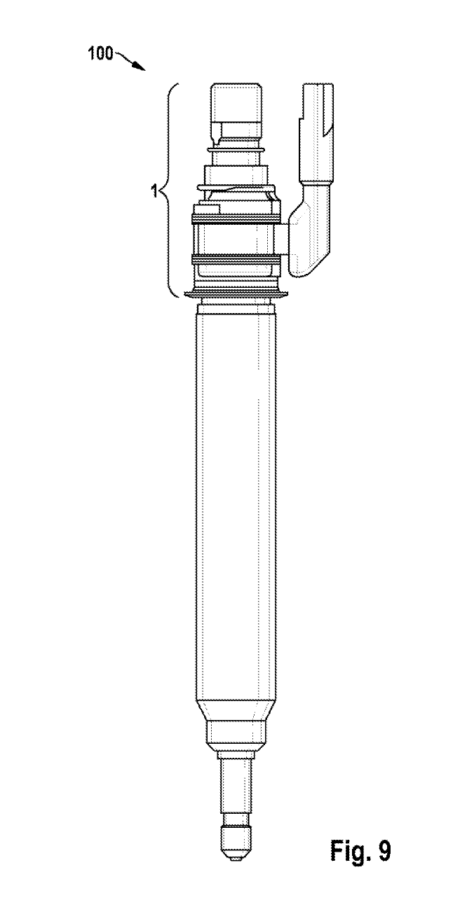

FIG. 9 shows a fuel injector 100. This fuel injector 100 includes a component 1 according to one of the previously described specific embodiments.

1-11. (canceled)

12. A component, comprising:
a base part;
a sealing element; and
an extrusion coat that at least partially extends around the base part and at least partially around the sealing element, wherein the extrusion coat retains the sealing element in an elastically deformed state.

13. The component as recited in claim 12, wherein the sealing element and the base part define a sealed space between them, in which a gas is situated.

14. The component as recited in claim 13, wherein the gas is a compressed gas.

15. The component as recited in claim 13, wherein the base part has a recess covered by the sealing element and creating the space between the base part and the sealing element.

16. The component as recited in claim 13, wherein the sealing element has one of a cup shape and a bowl shape provided with an opening, the opening being covered by the base part and creating the space between the base part and sealing element.

17. The component as recited in claim 13, wherein the base part has two surfaces angled relative to each other, wherein the sealing element extends between the angled surfaces thereby creating the space between the base part and sealing element.

18. The component as recited in claim 12, wherein at least one of the base part and the sealing element is completely surrounded by the extrusion coat.

19. The component as recited in claim 12, wherein the sealing element rests against two surfaces of the base part without interruption, the surfaces being situated at an angle with respect to each other.

20. A method for producing an extrusion-coated component, comprising:
providing a base part and a sealing element;
securing the sealing element on the base part; and
at least partially extrusion-coating the base part and the sealing element by an additional material, the sealing element being elastically deformed in the process.

21. The method as recited in claim 20, wherein the securing of the sealing element on the base part creates a sealed space between the base part and the sealing element, and wherein a gas enclosed in the space is compressed during the extrusion coating by the elastic deformation of the sealing element.

22. The method as recited in claim 20, wherein the sealing element is placed without interruption against two angled surfaces of the base part, and wherein the sealing element is pressed into a cavity of an injection molding die by the elastic deformation during the extrusion coating.

23. A fuel injection device for an internal combustion engine, comprising:
a component that includes:
a base part;
a sealing element; and
an extrusion coat that at least partially extends around the base part and at least partially around the sealing element, wherein the extrusion coat retains the sealing element in an elastically deformed state.
